(19) United States
(12) Patent Application Publication
(10) Pub. No.: US 2018/0147523 A1
(43) Pub. Date: May 31, 2018

(54) WET AIR PURIFIER

(71) Applicant: Moon-sub OH, Jeollabuk-do (KR)

(72) Inventor: Moon-sub OH, Jeollabuk-do (KR)

(21) Appl. No.: 15/572,665

(22) PCT Filed: May 3, 2016
(86) PCT No.: PCT/KR2016/004644

§ 371 Date: Nov. 8, 2017

(30) Foreign Application Priority Data
May 11, 2015 (KR) 10-2015-006598

(51) Int. Cl. B01D 47/06; B01D 47/16; F24F 3/14

(52) U.S. Cl. CPC B01D 47/06; F24F 3/14; B01D 47/16

(57) ABSTRACT

Disclosed is a wet air purifier that eliminates contaminants while contaminated air passes therethrough by causing the contaminated air to come into contact with water. The wet air purifier suctions external air by rotating a rotary fan installed therein and disperses water droplets by causing water to collide with a rotary fan to increase a contact surface between air and water. In the wet air purifier, a mixture of the contaminated external air and the water is made to pass through a long narrow passage and guided to a storage tank in which contaminants are settled. In this way, the wet air purifier increases a retention time and a collision time of water and contaminated air. The wet air purifier also can function as a humidifier.

### CROSS REFERENCE TO RELATED APPLICATIONS

This application is a 371 application for international patent application PCT/KR2016/004644 filed 3 May 2016, which claims priority to Korean provisional patent application No. 10-2015-0065098 filed 11 May 2015, which is incorporated herein by reference in its entirety.

### TECHNICAL FIELD

The present invention relates to a wet air purifier. More particularly, the present invention relates to a wet air purifier functioning as a humidifier that humidifies an indoor space as well as an air purifier that eliminates contaminates from contaminated air by passing the contaminated air therethrough such that the contaminants come into contact with water therein, wherein: when a rotary fan is rotated, contaminated air is introduced into the wet air purifier and water introduced into the wet air purifier comes into contact with and collides with the rotary fan that is rotating such that the water is scattered and dispersed as fine water droplets, which increases a contact area between water and air; water onto which contaminants in the contaminated air are adsorbed moves along an air flow caused by the rotary fan through a long narrow path, which increases a retention time and a collision time of water and air; and the waste water is guided to a storage tank in which the contaminants are settled.

### BACKGROUND ART

In general, an air purifier is an apparatus that eliminates contaminants by passing contaminated air containing fine dust, various harmful gases, various bacteria, mold, viruses, etc. through a purification medium and then discharges clean air.

The air purifier has not only an air purification function but also other useful functions such as a function of eliminating small particles (for example, smells, ticks, pollen, pet fur, etc.), a function of preventing airborne infection diseases, etc.

Air purifiers are categorized into dry air purifiers and wet air purifiers. Dry air purifiers are categorized into an electrostatic precipitation type and a filter purification type.

The electrostatic precipitation type has an advantage of not requiring replacement of a filter because it is not equipped with a filter. However, the electrostatic precipitation type has a disadvantage of deterioration of a purification capacity and a dust removal performance when dust accumulates on an electrostatic precipitator.

Meanwhile, the filter purification type exhibits a high purification performance because various kinds of fine particles are removed while air flows through a filter. Therefore, the filter purification type is suitable for filtering out yellow dust from air. However, this type has a disadvantage of requiring maintenance cost such as filter replacement cost because filter replacement has to be periodically performed.

A wet air purifier purifies air in a manner of bringing suctioned air into contact with water and causing contaminants in air to be settled. Therefore, it needs no filter replacement, and generates less noise. Furthermore, it has a humidification function. For these reasons, a wet air purifier is advantageous over a dry air purifier.

However, a conventional wet air purifier suffers frequent malfunctioning attributable to scale buildup because a sensor that detects the water level operates in a state of being in direct contact with water. In addition, when pumping water, a pumping fan and water stored in a casing simultaneously rotate. Therefore, it is difficult to secure a predetermined pumping amount. In this case, sprayed water and suctioned air cannot sufficiently come into contact with each other, and thus air purification efficiency is deteriorated.

### DISCLOSURE

### Technical Problem

Accordingly, the present invention has been made keeping in mind the above problems occurring in the related art, and an objective of the present invention is to purify air in a manner of: forcibly introducing contaminated air into an air purifier by operating a rotary fan horizontally or vertically installed in the air purifier; spraying clean water stored in a storage tank into the air purifier such that the sprayed water collides with the contaminated air introduced by the horizontal or vertical rotary fan that is rotating due to centrifugal force of the introduced external air, thereby dispersing the water as fine water droplets, which ensures sufficient contact between air and water so that contaminants in the contaminated air can be easily adsorbed onto the water; and passing the water containing the contaminants through a long narrow channel configured to increase a retention time such that the water is introduced into a storage tank.

Another objective of the present invention is to maximize adsorption efficiency of fine particles contained in external air onto water by causing the external air introduced by the rotary fan to come into contact with sprayed water and by passing a contaminants-water mixture through a long narrow channel using the speed of air movement caused by the rotary fan.

### Technical Solution

In order to accomplish the above object, the present invention provides a wet air purifier including: an outer cover having a top surface made of a perforated member and a closed outer side surface; an air discharge portion provided under the outer cover and having a plurality of discharge holes each of which is open at a bottom and at an outer side surface thereof and a plurality of through-holes each of which is open at a top surface thereof and is disposed at an inner position than the discharge hole; a storage tank installed under the air discharge portion and provided with a purification container installed therein; a cross-flow rotary fan installed in the outer cover and connected to a motor coupled to a top center portion of the air discharge portion; an inner cover installed between the outer cover and the rotary fan and having an open top and a closed outer side surface; and a nozzle portion installed at an upper end of the inner cover and connected to an end of a transfer pipe that is connected to a pump installed in the purification container of the storage tank at a lower end thereof and which extends upward to pass through the air discharge portion and through a space portion between the outer cover and the inner cover, the nozzle portion having a flow channel formed therein and a plurality of nozzle holes formed at a bottom surface thereof.

The wet air purifier may further include an axial-rotary fan including a rotary shaft connecting the motor and the cross-flow rotary fan.

On the other hand, instead of the cross-flow rotary fan, the motor, and the inner cover described above, an axial-flow rotary fan is installed in the outer cover and connected to a motor coupled to a bottom center portion of a perforated member of the outer cover; a transfer pipe connected to the pump is bifurcated to extend toward opposite ends of the outer cover and then to extend upward; ends of the upward extended portions of the transfer pipe are provided with respective nozzles holes; and a filter portion is installed between the bifurcated portions of the transfer pipe in the outer cover.

On the other hand, instead of the transfer pipe described above, an upper end portion of the purification container may be disposed in the outer cover and may be provided with a convex hemispherical cap; a transfer pipe may have a lower end connected to the pump installed in the purification container, may extend upward through a top center portion of the hemispherical cap of the purification container, may bifurcate at a position above the hemispherical cap, and may have upper ends provided with respective nozzle portions; and an inner cover may be installed between the outer cover and the purification container installed in the outer cover.

On the other hand, in the wet air purifier, an upper end portion of the inner cover may be provided with a slipping portion that is bent outward from the upper end of the inner cover, has a horizontally extended portion, and is attached to an inner surface of the outer cover in a surface contact manner.

On the other hand, in the wet air purifier, the inner cover may have an inner diameter that gradually decreases toward a lower end thereof.

On the other hand, in the wet air purifier, an inner surface of the inner cover and an outer surface of the purification container are provided with a plurality of protrusion bars arranged in a zigzag pattern.

Alternatively, there is provided a wet air purifier including: a housing having an inside space divided into a suction portion that is an upper portion thereof, a discharge portion that is a middle portion thereof, and a storage portion that is a lower portion thereof: a first barrier horizontally installed between the suction portion and the discharge portion; a second barrier horizontally installed between the discharge portion and the storage portion; a shielding film coupled to a rear end of the first barrier in a surface contact manner and extending upward by a predetermined length, and coupled to a rear end of the second barrier in a surface contact manner and extending downward; a vertically extending narrow space portion provided between the shielding film and an inside rear surface of the housing; a cross-flow rotary fan horizontally installed in the suction portion and connected to a motor coupled to a portion of the suction portion; a third barrier vertically installed to divide an inside space of the storage portion into a waste section and a purification section; an inflow hole formed to pass through the third barrier; a transfer pipe connected to a pump installed in the purification section and extending upward to pass through the discharge portion and the suction portion; a nozzle bar horizontally installed, connected to an upper end of the transfer pipe, disposed at an upper end portion of the suction portion, and provided with a plurality of nozzle holes arranged at intervals in a horizontal longitudinal direction thereof; and perforated members each having a plurality of through-holes and respectively installed at a front portion of the housing and in the second barrier.

In the space portion, the surface of the shielding film and the inside rear surface of the housing may be provided with concavities or convexities.

### ADVANTAGEOUS EFFECTS

As described above, the wet air purifier of the present invention operates such that external contaminated air is introduced thereinto when a horizontal or vertical rotary fan installed therein is rotated and clean water stored in a storage tank is sprayed thereinto such that the clean water collides with a rotating rotary fan to become fine water droplets that scatter in the wet air purifier and come into contact with the contaminated air. Thus, the contaminants in the contaminated air are adsorbed onto the water droplets and the water containing the contaminants is introduced into a storage tank. The water and the external air move through a long narrow channel, along an air flow caused by the rotary fan. This increases a contact area and a contact time for contact between fine dust in the external air and the water, thereby improving a dust adsorption performance through sufficient contact between the fine dust and the water and discharging only purified air.

### DESCRIPTION OF DRAWINGS

FIG. 1 is a perspective view of a wet air purifier according to the present invention;

FIG. 2 is an exploded assembly view of the wet air purifier according to the present invention;

FIG. 3(a) is a perspective view, FIG. 3(b) is a partially-cut perspective view and FIG. 3(c) is a plan view of an air discharge portion of the wet air purifier according to the present invention;

FIG. 4 is a view illustrating the detailed structure of a support portion on an inside bottom surface of a storage tank of the wet air purifier according to the present invention;

FIG. 5(a) is a perspective view, FIG. 5(b) is a perspective view and FIG. 5(c) is a bottom perspective view of a nozzle portion of the wet air purifier according to the present invention;

FIG. 6 is a sectional view illustrating air flow and water flow caused by operation of the wet air purifier according to the present invention;

FIG. 7 is a sectional view illustrating air flow and water flow caused by operation of the wet air purifier equipped with an axial-flow rotary fan according to the present invention;

FIG. 8 is a sectional view illustrating air flow and water flow caused by operation of the wet air purifier equipped with an axial-flow rotary fan and a filter portion in an outer cover according to the present invention;

FIG. 9 is a sectional view illustrating air flow and water flow caused by operation of the wet air purifier equipped with an axial-flow rotary fan and a purification container capped with a hemispherical cap according to the present invention;

FIG. 10 is a sectional view illustrating air flow and water flow caused by operation of the wet air purifier of FIG. 9, in which a slip portion is formed at an upper end of an inner cover according to the present invention;

FIG. 11 is a sectional view of the wet air purifier according to the present invention in which an inner cover and a purification container are provided with protrusions bars;

FIG. 12 is a sectional view of the wet air purifier according to the present invention in which an inside circumferential surface of the inner cover is provided with protrusion bars;

FIG. 13 is a sectional view illustrating air flow and water flow caused by operation of the wet air purifier having a rhombic inner cover according to the present invention;

FIG. 14 is a perspective view of an inner cover in the wet air purifier according to the present invention;

FIG. 15 is a perspective view illustrating the shape of a housing of the wet air purifier according to the present invention;

FIG. 16 is a perspective view illustrating the internal structure of the wet air purifier with a front portion removed according to the present invention;

FIG. 17 is an assembly view of a horizontal cross-flow rotary fan and a motor in the wet air purifier, according to the present invention;

FIG. 18 is a perspective view illustrating a sequential connection of a motor, a transfer pipe, and a nozzle in the wet air purifier of FIG. 15 according to the present invention;

FIG. 19 is a structural view of the wet air purifier of FIG. 15 according to the present invention in which a shielding film is provided at a relatively rear side position in an inside space of the housing;

FIG. 20 is a sectional view illustrating air flow and water flow caused by operation of the wet air purifier of FIG. 15 according to the present invention;

FIG. 21 is a sectional view illustrating air flow and water flow caused by operation of the wet air purifier having concavities or convexities on wall surfaces in an inside space portion in the wet air purifier of FIG. 15, according to the present invention.

### BEST MODE

In order to accomplish the above objectives, embodiments will be described below with reference to the drawings.

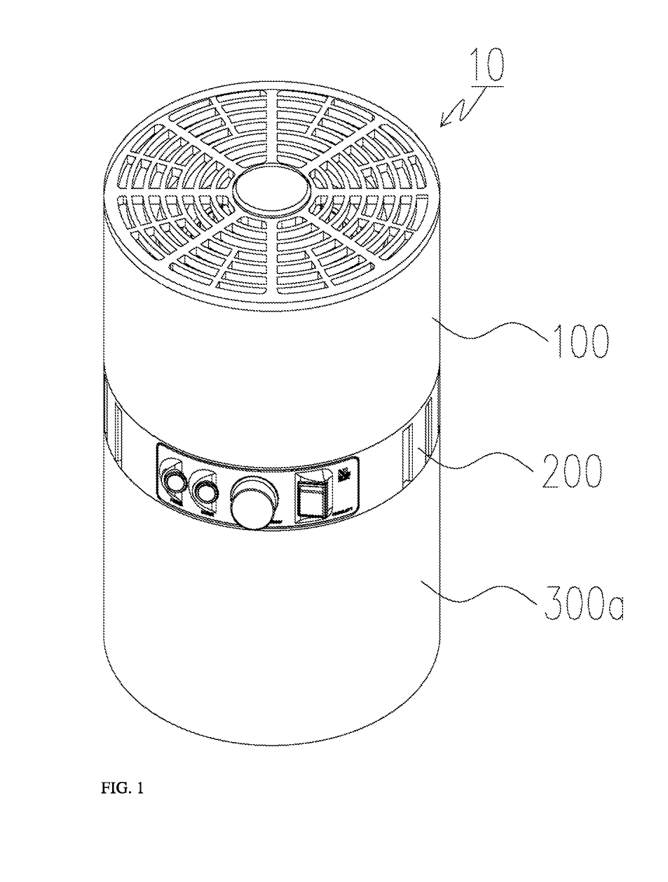

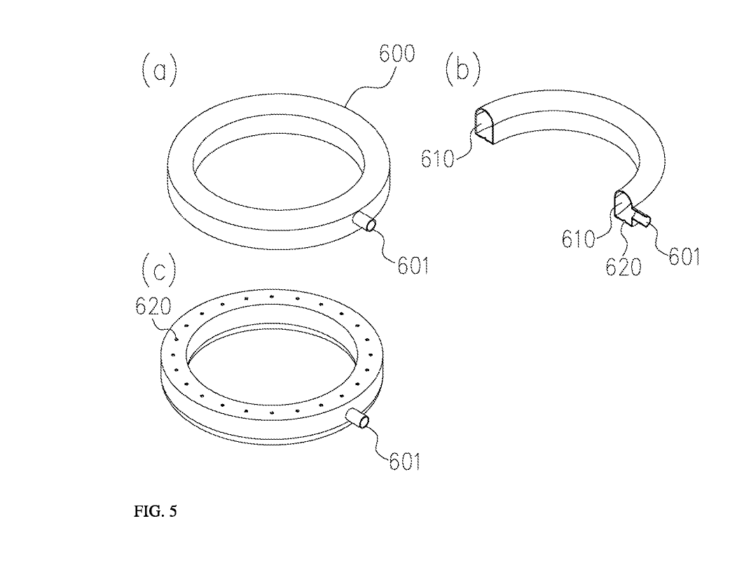

As illustrated in FIGS. 1 to 6, a wet air purifier 10 (hereinafter, simply referred to as ‘air purifier’) is provided. The wet air purifier 10 includes: an outer cover 100 having a closed side surface and a top surface made of a perforated member 110 having a plurality of through-holes; an air discharge portion 200 provided under the outer cover 100 and having a plurality of discharge holes 210 formed to open at a side surface thereof and a bottom surface thereof and a plurality of through-holes 220 provided at an inner position than the discharge holes 210 and formed to open at a top surface thereof; a storage tank 300a installed under the air discharge portion 200 and provided with a water purification container 300b installed therein; a cross-flow rotary fan 400a connected to a motor 420 coupled to a top center portion of the air discharge portion 200 and installed in the outer cover 100; an inner cover 500 provided between the outer cover 100 and the rotary fan 400a and having an open top and a closed side surface; and a nozzle portion 600 provided at an upper end of the inner cover 500, connected to an end of a transfer pipe 320 that is connected to a pump 310 installed in the water purification container 300b of the storage tank 300a at an upper end thereof and which extends upward through the air discharge portion 200 and through a space between the outer cover 100 and the inner cover 300, and provided with a flow channel 610 formed therein and a plurality of nozzle holes 620 formed at a bottom surface thereof.

The structure of the wet air purifier 10 according to this embodiment is mainly composed of the outer cover 100, the air discharge portion 200, the storage tank 300a, the cross-flow rotary fan 400a, the inner cover 500, and the nozzle portion 600.

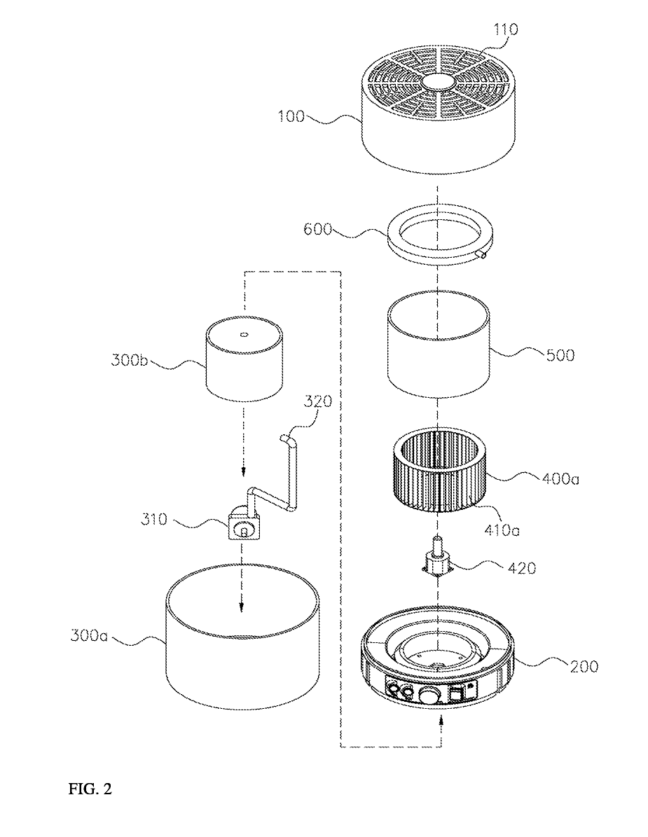

As illustrated in FIGS. 1 and 2, the outer cover 100 is provided as a top member of the air purifier 10. The outer cover 100 has a top surface provided by a perforated member 110 having a plurality of through-holes, a closed side surface, and an open bottom.

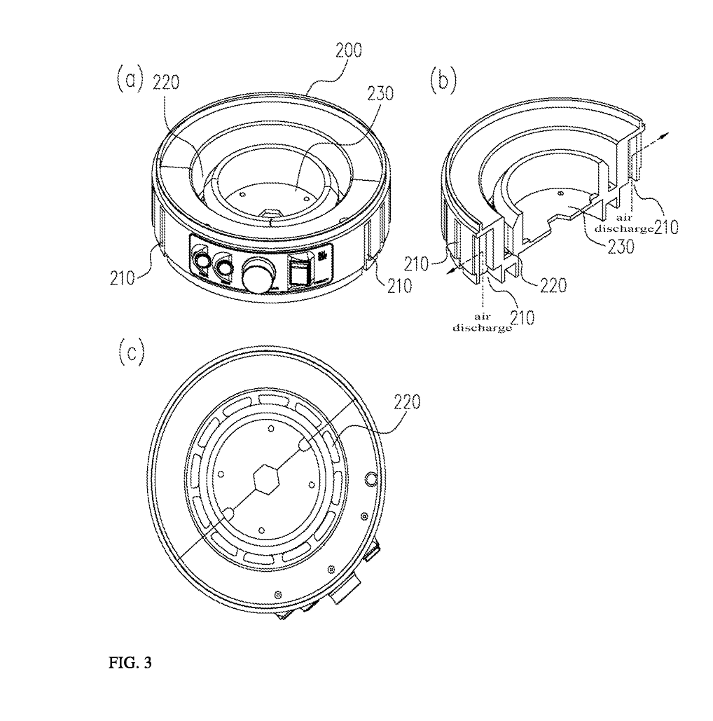

As shown in FIGS. 2 and 3, the air discharge portion 200 is fixedly installed under the outer cover 100 and includes the discharge holes 210 each of which is open at the bottom and at the outer side surface of the body of the air discharge portion 200. The discharge holes 210 are arranged at intervals in the circumferential direction of the air discharge portion 200. Purified air introduced into the air discharge portion 200 from the storage tank 300a is discharged out of the air purifier 10 through the discharge holes 210. The discharge holes 200 arranged at regular intervals in the circumferential direction of the bottom of the air discharge portion 200 are disposed to face an inside space of the storage tank 300a so that air in the storage tank 300a can be discharged through the discharge holes 210 that are open at the outer side surface of the body of the air discharge portion 200.

In the air discharge portion 200, the through-holes 220 are formed at a more inner position than the discharge holes 210 formed at the bottom of the air discharge portion 200, and the through-holes 220 are open at the top surface of the air discharge portion 200. The through-holes 220 function as passages that guide external air and water introduced into the air purifier by the rotary fan 400a and the nozzle portion 600 such that the external air and the water are introduced into the storage tank 300a.

An installation plate 230 to which a lower end of the motor 420 is fixed is provided at the top center portion of the air discharge portion 200, i.e. an inner position than a position where the through-holes 220 are arranged. The installation plate 230 and the air discharge portion 300 are unitarily formed.

A controller (not shown) is provided at a portion of the outer side surface of the air discharge portion 200. When the air purifier is powered by a power supply unit, the controller controls the operation of the motor and the pump. That is, the controller controls the operation speed and the operation time of the motor. The controller also has an automatic switching-off function that turns off the air purifier and a warning function of warning an operator of an abnormal state of the air purifier, on the basis of information detected by a water level sensor.

In addition, a humidity sensor is also provided in the controller. The controller further includes a display unit that displays a current humidity and a desired humidity and a manipulation unit that enables a user to change settings of the humidity.

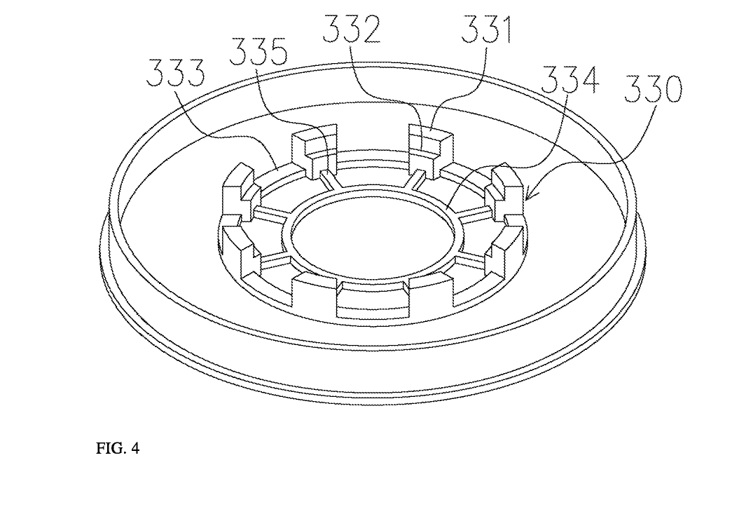

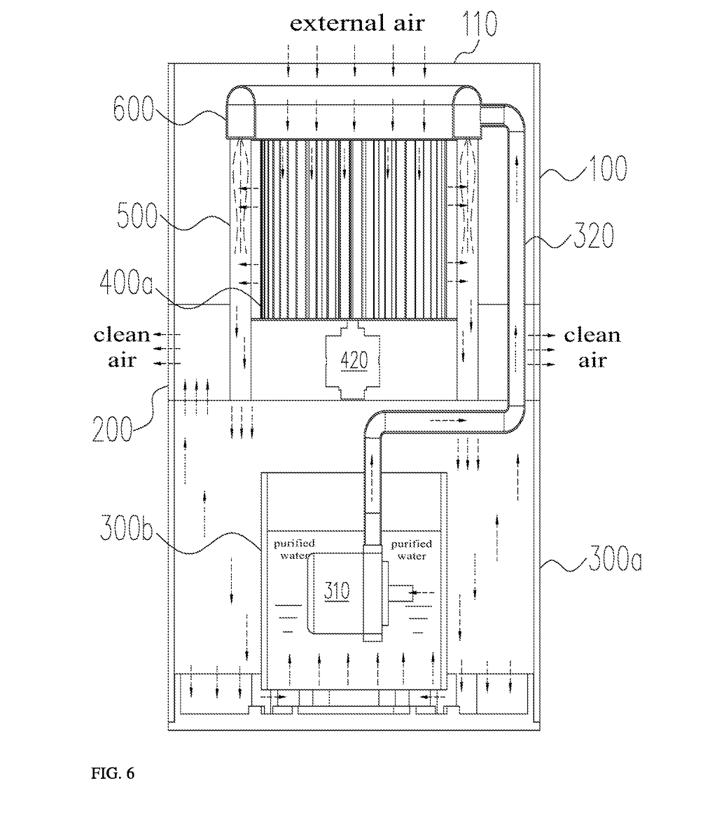

As illustrated in FIGS. 2 and 6, the storage tank 300a is fixedly installed under the air discharge portion 200 and includes the purification container 300b installed therein. The top of the purification container 300b is closed and the bottom of the purification container 300b is open. The transfer pipe 320 extends to pass through the closed top surface of the purification container 300b and is connected to the pump 310 installed in the purification container 300b at a lower end thereof. The transfer pipe 320 also extends upward from the purification container 300b. As illustrated in FIG. 4, a support portion 330 is installed in the storage tank 300a and under the purification container 300b. The support portion 330 includes multiple fixing pieces 331 provided with podium portions 332 on inner surfaces thereof. The fixing pieces 331 are arranged at intervals in a circular circumferential direction. The purification container 300b is installed such that a lower end of the purification container 300b is in surface contact with the podium portions 332 of the fixing pieces 331. The multiple fixing pieces 331 are fixedly installed on the inside bottom surface of the storage tank 300a and arranged in accordance with the shape of the lower end of the purification container 300b. For example, when the lower end of the purification container 300a has a ring shape, the fixing pieces 331 are fixed to the inside bottom surface of the storage tank 300a while being arranged in a circular circumferential direction.

There are provided multiple first connection taps 333 each of which connects the fixing pieces 331 adjacent to each other. The first connection taps 333 have a height lower than that the podium portions 332 of the fixing pieces 331. Lower ends of the first connection taps 333 are fixed to the inside bottom surface of the storage tank 300a.

A ring-shaped protrusion tap 334 is disposed at an inner position than the multiple fixing pieces 331 and is fixed to the inside bottom surface of the storage tank 300a. There are multiple second connection taps 335 each of which connects the protrusion tap 334 with a corresponding one of the fixing pieces 331. The second connection taps 335 are fixed to the inside bottom surface of the storage tank 300a.

The support portion 330 is composed of the fixing pieces 331, the first connection taps 333, the protrusion tap 334, and the second connection taps 335. The lower end of the purification container 300a is installed to be in tight surface contact with the podium portions 332 of the fixing pieces 331.

When ‘water containing fine dust’ (hereinafter, referred to as contaminated water) in the storage tank 300a is introduced into the purification container 300b, the contaminated water is introduced into the purification container 300b through gaps between the adjacent fixing pieces 331 of the support portion 330. At this time, the fine dust contained in the contaminated water is skimmed by the first connection taps 333, the second connection taps 335, and the protrusion tap 334 such that only purified water can be introduced into the purification container 300b.

That is, the support portion 330 serves as a barrier wall that prevents the fine dust from being introduced into the purification container 330b of the storage tank 300a. Therefore, only clean water with no fine dust can be introduced into the purification container 300b.

A filter member (not shown) is installed to be in tight surface contact with the outer surfaces of the fixing pieces 331 such that the gaps between the adjacent fixing pieces 331 are reduced. The filter member filters out the fine dust contained in the water.

As illustrated in FIGS. 2 and 6, the cross-flow rotary fan 400a is vertically arranged. That is, a plurality of blades 410a is arranged in the vertical direction. As the rotary fan 400a, an existing fan operating on the principle in which air around the rotary fan 400a is introduced into the rotary fan 400a and is then discharged through a lower end of the rotary fan 400a when the blades are rotated is used. The rotary fan 400a is installed in the outer cover 100 and is connected to the motor 420 coupled to the top center portion of the air discharge portion 200.

When the motor 420 is operated, the rotary fan 400a rotates in one direction such that external air is forcibly introduced into the outer cover 100 through the perforated member 110 of the outer cover 100 and the air in the outer cover 100 is moved to the lower end of the rotary fan 400a.

As illustrated in FIGS. 2 and 6, the inner cover 500 is installed between the outer cover 100 and the rotary fan 400a, has a closed outer side surface, and is open at the bottom thereof. A lower end of the inner cover 500 with the rotary fan 400a installed therein is fixed to the top surface of the air discharge portion 200.

When the rotary fan 400a rotates, external air is first introduced into the outer cover 100 through the perforated member 110 at the top surface of the air discharge portion and is then introduced into the inner cover 500. During a period in which the external air flows in this way, water is sprayed by the nozzle portion 600 due to the rotary motion of the rotary fan 400a. Thus, the sprayed water comes into contact with the air and is then introduced into the storage tank 300a through the space portion provided between the inner cover 500 and the rotary fan 400a and through the through-holes 220 of the air discharge portion 200. The through-holes 220 of the air discharge portion 200 are disposed in a lower portion of the space portion between the inner cover 500 and the rotary fan 400a, and the lower end of the inner cover 500 is fixed to the outer periphery of the air discharge portion 200, specifically at a position outside the through-holes 220. The lower end of the inner cover 500 is sealed to prevent the contaminated water from leaking outside from the lower end of the inner cover 500. The air introduced into the storage tank 300a is discharged out of the air purifier 10 through the discharge holes 210 of the air discharge portion 200. The air discharged out of the air purifier is clean air from which fine dust is removed.

In addition, as illustrated in FIGS. 2, 5, and 6, the nozzle portion 600 is fixed at the upper end of the inner cover 500. The nozzle portion 600 has the flow channel 610 formed therein and the nozzle holes 620 formed at the bottom surface thereof.

A connection piece formed to communicate with the flow channel 610 is provided at the outer peripheral surface of the nozzle portion 600 such that the connection piece is connected to an end of the transfer pipe 320 that is connected to the pump 310 installed in the purification container 300b of the storage tank 300a at the lower end thereof and which extends to pass through the air discharge portion 200 and through the space portion between the outer cover 100 and the inner cover 500. Thus, when the pump 310 is operated, the water contained in the purification container 300b is introduced into the flow channel 610 of the nozzle portion 600 through the transfer pipe 320 and is then sprayed through the nozzle holes 620 formed at the bottom surface of the nozzle portion 610.

The nozzle holes 620 of the nozzle portion 600 fixed to the upper end of the inner cover 500 are oriented toward an inside space of the inner cover 500 such that water from the nozzles 620 is sprayed to be introduced into the inside space of the inner cover 620.

A connection piece 630 vertically extends from a lower outer periphery of the nozzle portion 600 by a predetermined length. The connection piece 630 is press-fitted into the upper end of the inner cover 500, thereby preventing the nozzle portion 600 from being separated from the inner cover 500.

Instead of the nozzle holes 620 formed at the bottom surface of the nozzle portion 600, the air purifier 10 may have nozzles holes 620 formed at an inner peripheral surface of a ring-shaped nozzle portion 600 such that water can be sprayed into the rotary fan 400a and the inner cover 500.

A process of purifying air by using the constituent elements of the wet air purifier according to one embodiment of the present invention will be described with reference to air flow and water flow shown in FIG. 6.

First, when the rotary fan 400a is rotated by the motor 420, external air is introduced into the outer cover 100 through the perforated member 10 disposed at the top of the outer cover 100. At this time, water contained in the purification container 300b is introduced into the flow channel 610 of the nozzle portion 600 through the transfer pipe 320 by operation of the pump 310. The water is then sprayed into the inner cover 500 through the nozzle holes 620. The external air and the water introduced and sprayed into the inner cover 500 by the rotary fan 400a and the nozzle portion 600 collide with each other and collide with the surface of the inner cover 500 due to the rotation speed of the rotary fan 400a. Thus, water droplets and fine dust contained in the external air comes into contact with each other such that the fine dust is adsorbed onto the water droplets. At this time, the water and air move down along an air flow path, through the passage provided between the inner cover 500 and the rotary fan 400a due to the rotation of the rotary fan 400a and then flow into the storage tank 300a through the through-holes 220 of the air discharge portion 200. When water onto which fine particles are adsorbed is introduced into the storage tank 300a, the water is stored in the storage tank 300a but the air is discharged out of the air purifier as clean water through the discharge holes 210 of the air discharge portion 200 after colliding the surface of the water stored in the storage tank 300a or the inner surface of the storage tank 300a.

The contaminated water stored in the storage tank 300a is purified by being introduced into the purification container 300b stably fixed to the podium portions 332 of the fixing pieces 331 through the gaps between the adjacent fixing pieces 331 of the support portion 330 fixed on the inside bottom surface of the storage tank 300a, and thus purified water is introduced into and stored in the purification container 300b.

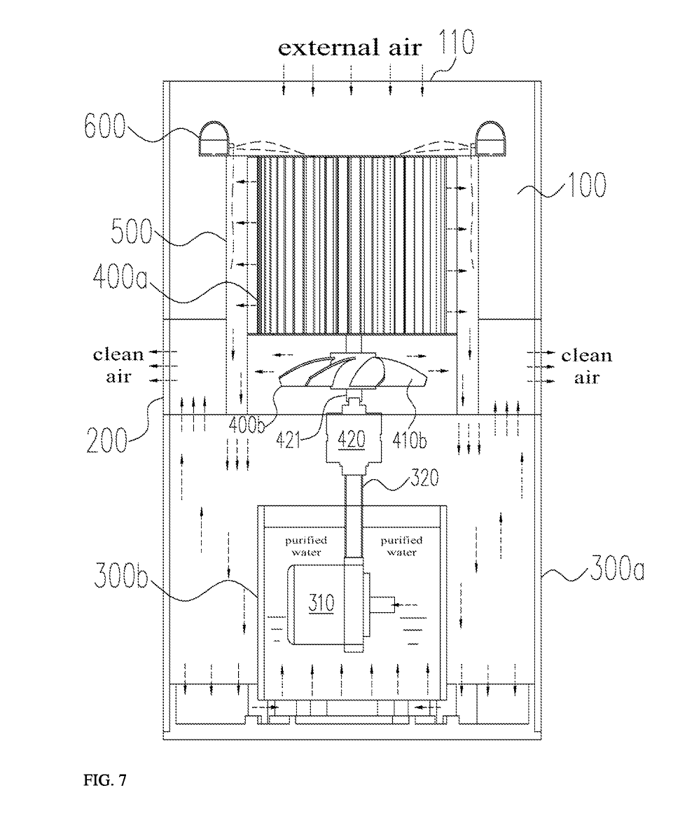

In addition, as illustrated in FIG. 7, in the wet air purifier 10, an axial-flow rotary fan 400b may be further installed between the motor 420 and the cross-flow rotary fan 400a and is structured such that a plurality of blades 410b is arranged in a radial pattern and attached to a rotary shaft 420 that connects the motor 420 with the cross-flow rotary fan 400a.

The cross-flow rotary fan 400a causes water and air to collide with each other and to move down along the wall surface of the inner cover 500 and through the passage provided between the inner cover 500 and the rotary fan 400a. In addition, the axial-flow rotary fan 400b provided at a lower-end of the cross-flow rotary fan 400a causes the water and air moving down along the wall surface of the inner cover 500 and through the passage between the inner cover 500 and the rotary fan 400a to collide with each other or to come into contact with or collide with the wall surface of the inner cover 500 such that fine dust in the air is well adsorbed onto the water. In this case, when the rotary shaft 421 is rotated by the motor 420, the cross-flow rotary fan 400a and the axial-flow rotary fan 400b are simultaneously rotated.

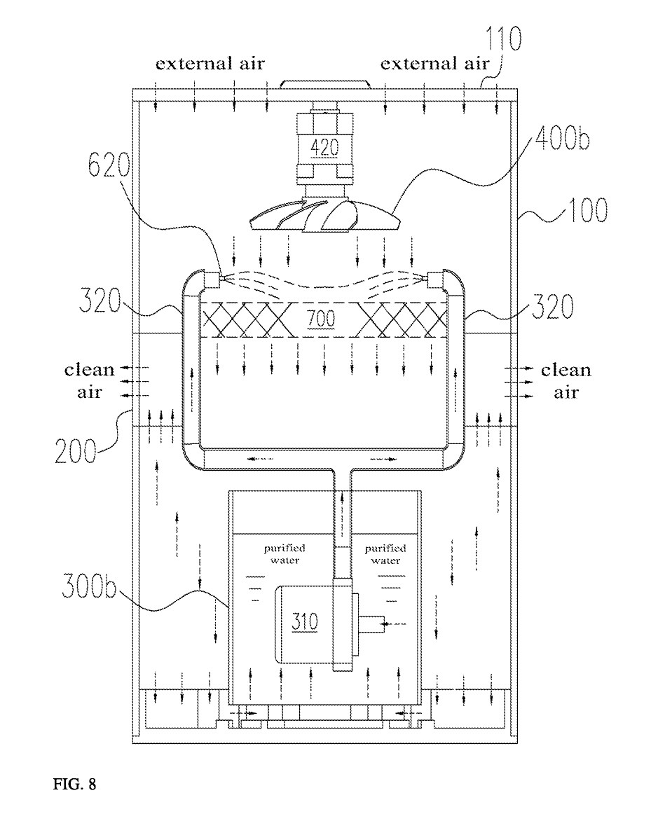

Alternatively, the wet air purifier 10 may have the structure illustrated in FIG. 8 instead of having the cross-flow rotary fan 400a, the motor 420, and the inner cover 500. That is, a motor 420 may be coupled to a bottom center portion of the perforated member 110 of the outer cover 100; an axial-flow rotary fan 400b may be installed in the outer cover 100; a transfer pipe 320 connected to the pump 310 is bifurcated to first extend toward opposite periphery portions of the outer cover 100 and then to extend upward, and is provided with nozzle holes 620 at ends of upward extended portions thereof; and a filter portion 700 may be installed between the horizontally extended portions of the transfer pipe 320 in the outer cover 100.

When the motor 420 installed on the lower surface of the perforated member 110 of the outer cover 100 is driven, the axial-flow rotary fan 400b connected to the motor 420 is rotated and thus external air is introduced into the outer cover 100 through the perforated member 110. At this time, the pump 310 installed in the purification container 300b is operated such that water is introduced into the transfer pipe 320 and is then sprayed through the nozzle holes 620 provided at the ends of the transfer pipe 320. Thus, the sprayed water comes into contact with and collides with external air to form a water-air mixture, and the water-air mixture permeates into the filter portion 700 installed between the bifurcated portions of the transfer pipe 320 within the outer cover 100. During this process, fine dust in the introduced external air is adsorbed onto the water, and the water-air mixture permeating into the filter portion 700 moves downward due to the weight of the water and the pneumatic pressure attributable to the flow of air caused by the rotary fan 400 and flows into the storage tank 300a.

The filter portion 700 is made of a material having a plurality of through-holes (not shown) formed to extend from the top surface to the bottom surface of the filter portion 700 or having a sponge form provided with a plurality of pores (not shown). That is, the filter portion 700 functions to increase a contact time or a contact area for contact between water and air so that the fine dust can be sufficiently adsorbed onto the water, rather than functioning to filter out the fine dust.

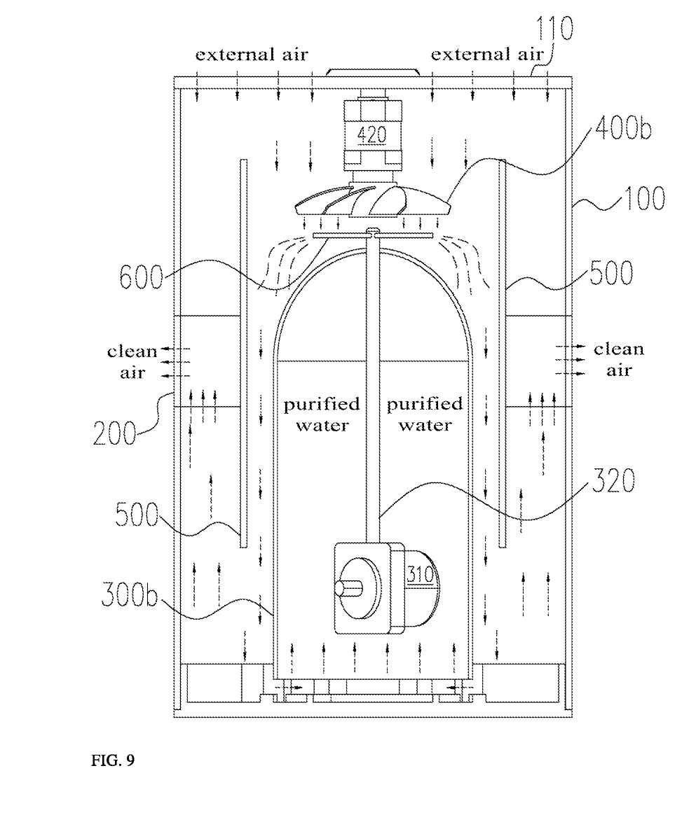

Alternatively, the wet air purifier 10 may have the structure illustrated in FIG. 9, instead of having the cross-flow rotary fan 400a and the motor 420 described above. That is, an axial-flow rotary fan 400b installed in the outer cover 100 is connected to a motor 420 coupled to the bottom center portion of the perforated member 110 of the outer cover 100; an upper end portion of the purification container 300b of the storage tank 300a is provided with a hemispherical cap that convexly protrudes and which is disposed in the outer cover 100; the transfer pipe 320 is connected to the pump 310 installed in the purification container 300b, extends upward to pass through the top center portion of the hemispherical cap of the purification container 300b, and bifurcates at a position above the hemispherical cap, in which the bifurcated portions of the transfer pipe extend upward and upper ends of the bifurcated portions are provided with respective pipe-shaped nozzle portions 500; and the inner cover 500 is installed between an inner surface of the outer cover 100 and an outer surface of the purification container 300b installed in the outer cover 100, in which the inner cover 500 extends downward such that a predetermined length of a lower end portion of the inner cover 500 is disposed in the storage tank 300a.

When external air is introduced into the outer cover 100 through the perforated member 100 of the outer cover 100 by the rotation of the rotary fan 400b, water is introduced into the transfer pipe 320 and is sprayed through the nozzle holes 620 arranged at regular intervals at the bottom surface of the nozzle portions 600 or the nozzle holes provided at the ends of the nozzle portions 600 extending upward from the hemispherical cap by operation of the pump 310. At this time, the external air is discharged out of the hemispherical cap while colliding an inner surface of the hemispherical cap and the external air and the water sprayed by the rotary fan 400b move downward through a passage between the inner cover 500 and the purification container 300b and flow into the storage tank 300a while colliding with and coming into contact with the wall surface of the inner cover 500.

The inner cover 500 extends downward in the storage tank 300a by a predetermined length, thereby increasing the length of the movement path of water and air, which is provided between the inner cover 500 and the purification container 300b. That is, the inner cover 500 functions to increase a contact time of water and air and thus fine dust in air can be sufficiently adsorbed onto water. In this case, the air discharge portion 200 is not provided with the through-holes 220 and the installation plate 230 but is provided with only a through-hole extending from the top to the bottom thereof.

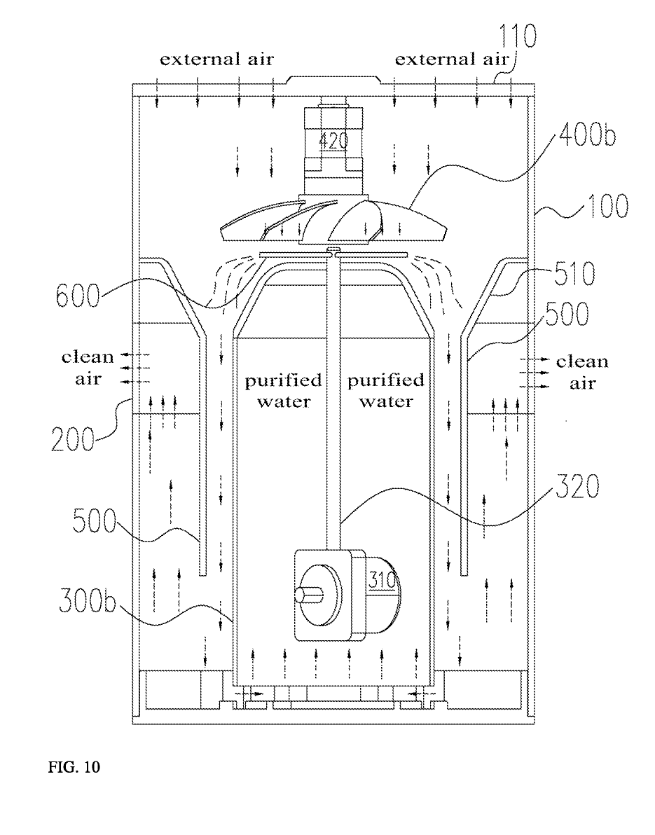

Alternatively, the wet air purifier 10 may be structured as illustrated in FIG. 10. That is, an upper end of the inner cover 500 is provided with a slipping portion 510 that is bent outward from the upper end of the inner cover 500 and an upper end portion thereof horizontally extends by a predetermined length. The upper end of the slipping portion 510 is attached to the inner surface of the outer cover 100.

Since the upper end of the inner cover 500 is provided with the slipping portion 510, the contact area on which the sprayed water and the external air introduced by rotation of the rotary fan 400b come into contact with is increased. That is, the water and the air do not directly fall through the space portion provided between the inner cover 500 and the purification container 300b, but first collide with the slip portion 510 before falling down. That is, the slip portion 510 increases a retention time of the water and the air in the air purifier, thereby enabling the fine dust in the air to sufficiently come into contact with the water.

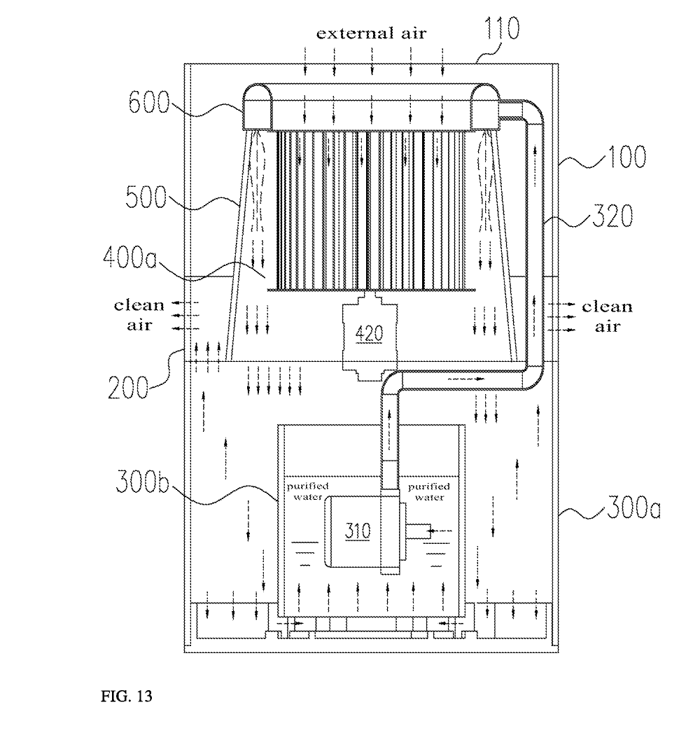

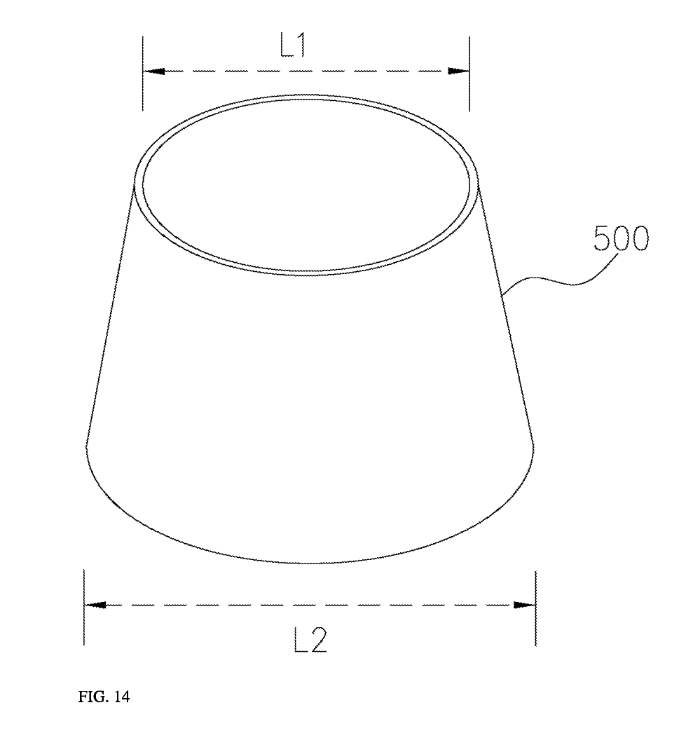

Alternatively, as illustrated in FIGS. 13 and 14, the wet air purifier 10 may have a structure in which the inside diameter of the inner cover 500 gradually increases toward the lower end thereof.

That is, as illustrated in FIG. 14, the inner cover 500 has an internal structure formed such that the inside diameter of the inner cover 500 gradually increases from a diameter L1 at an upper end thereof to a diameter L2 at a lower end thereof.

Due to the structure in which the inner cover 500 has the gradually changing inner diameter, when external air is introduced into the inner cover 500 by rotation of the rotary fans 400a and 400b, an air pressure difference occurs between the upper end and the lower end of the inner cover 500. That is, a space at the lower end of the inner cover 500 having a relatively larger inner diameter has a relatively lower pressure. Therefore, the air introduced into the upper portion of the inner cover 500 moves and quickly diffuses toward the lower end of the inner cover 500, and the water moving in the inner cover 500 moves at increased speed and diffuses to an increased area. Accordingly, air-water contact efficiency increases and thus dust in the air can be efficiently adsorbed onto the surface of water.

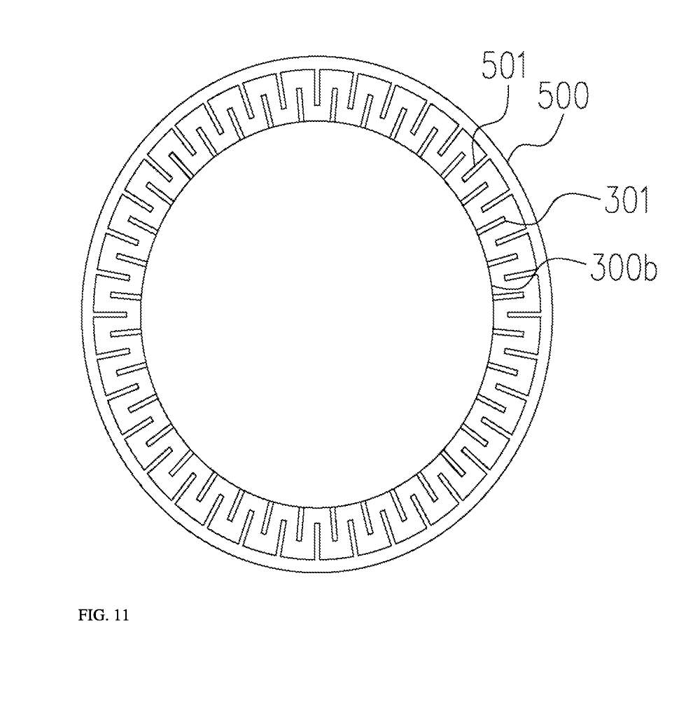

Alternatively, as illustrated in FIG. 11, the wet air purifier 10 may have the structure in which the inner surface of the inner cover 500 is provided with a plurality of protrusion bars 501, the outer surface of the purification container 300b is provided with a plurality of protrusion bars 301 and 501, and the protrusion bars 301 and 501 are arranged in a zigzag pattern.

Since the protrusion bars 301 and 501 provided on the outer surface of the purification container 301 and the inner surface of the inner cover 500 are arranged in a zigzag pattern, the retention time of the water and the air introduced into the inner cover 500 is increased.

Therefore, collision and contact between the water and the air are maximized, which enables the dust in the air to be completely adsorbed onto the surface of the water.

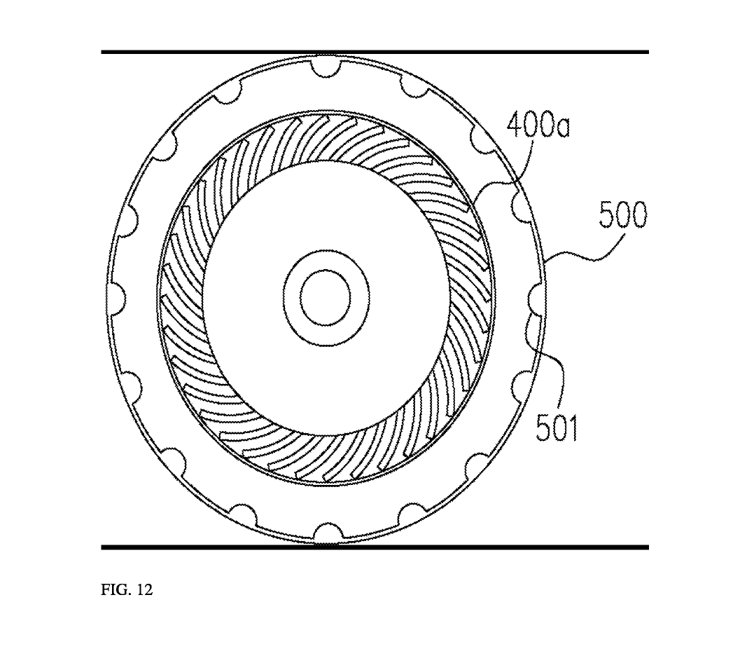

Alternatively, as illustrated in FIG. 12, the inner surface of the inner cover 500 is provided with the protrusion bars 501. Thus, the external air and the water collide with the protrusion bars 501, which increases a contact area on which the external air and the water come into contact with each other. Therefore, the fine dust in the external air can be sufficiently adsorbed onto the surface of the water.

In addition, the entire inner surface of the outer cover 100 of the air purifier 10, the top surface and the bottom surface of the air discharge portion 200, which are provided with the discharge holes 210 and the through-holes 220, the inner surface of the storage tank 300a, and the inner surface of the purification container 300b are coated with silver nanoparticles. The silver nanoparticles have a function of eliminating various bacteria and viruses contained in air and water so that the surfaces of the wet air purifier can be maintained in a hygienic state. The silver nanoparticles are formed by using a nano technology and function as a high-tech sterilizer having a strong antibacterial or sterilizing function. The silver nanoparticles are a high-tech sterilizer using a strong antibacterial or sterilizing function of silver and an electro-conductive mechanism with a good electromagnetic wave shield performance. Silver nanoparticles have a characteristic that bacteria and viruses have no resistance thereto unlike typical antibiotic agents. According to the results of experiments, it is confirmed that a silver nanomaterial has an effect of destroying most pathogenic bacteria on earth in a short time. Therefore, a silver nanomaterial is applied to all the constituent parts of the present invention, in or at which air and water are likely to come into contact with each other.

In addition, a ultraviolet (UV) sterilizing lamp (not shown) is provided in the outer cover 100 or at the lower surface of the air discharge portion 200. Thus, it is possible to remove various bacteria or viruses contained in the air or the water introduced or sprayed into the outer cover 100, thereby maintaining a hygienic environment in the air purifier.

The UV sterilizing lamp installed in the outer cover 100 may be installed on the lower surface of the perforated member 110 of the outer cover 100 or on the wall surface of the outer cover 100, thereby improving a sterilizing effect.

In the air purifier 10 equipped with the UV sterilizing lamp installed therein, when water in the air purifier 10 is completely discharged outside and the rotary fans 400a and 400b are operated such that only external air is forcibly introduced into the air purifier while no water is sprayed into the air purifier, the air purifier 10 functions as a dehumidifier by completely removing moisture in the external air with UV rays emitted from the UV sterilizing lamp.

In addition, as the pump 310 installed in the purification container 300b of the storage tank 300a, an existing pump having an automatic switching-off function may be used. That is, the pump 310 automatically stops operating when the amount of water in the purification container 300b is insufficient during the operation of the pump 310.

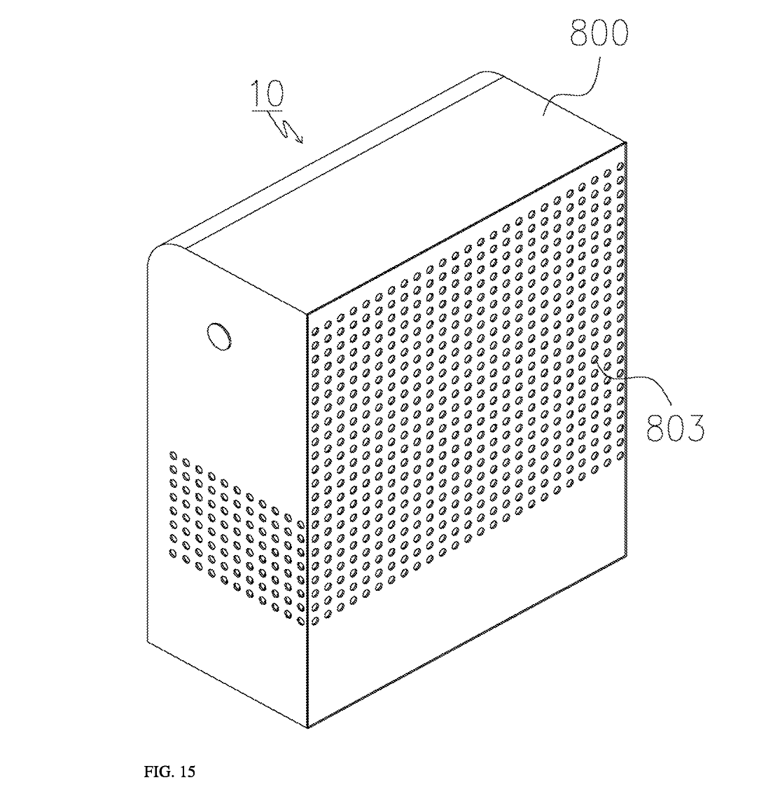

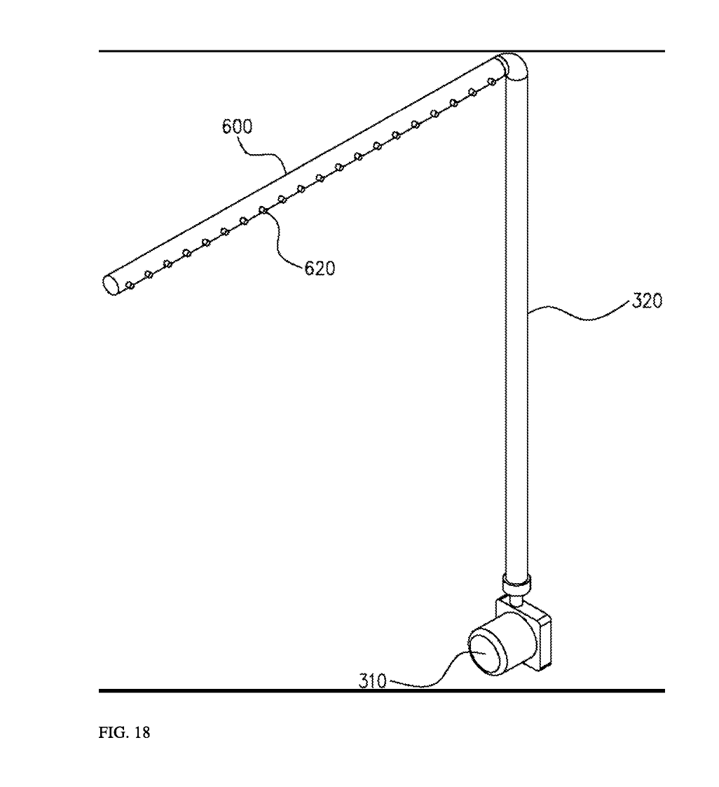

Alternatively, an air purifier 10 may have a structure illustrated in FIGS. 15 to 20. Referring to FIGS. 15 to 20, the air purifier 10 includes a housing 800 having an inside space divided into a suction portion 810 that is an upper portion, a discharge portion 820 that is a middle portion, and a storage portion 830 that is a lower portion. A first barrier 811 that is horizontally installed is provided between the suction portion 810 and the discharge portion 820 and a second barrier 821 that is horizontally installed is provided between the discharge portion 820 and the storage portion 830. A shielding film 801 is coupled to a rear end of the first barrier 811 in a surface contact manner and extends upward from the rear end of the first barrier 811 by a predetermined length. The shielding film 801 is also coupled to a rear end of the second barrier 821 in a surface contact manner and extends downward from the rear end of the second barrier 821. A narrow space 802 that is elongated in a longitudinal direction (vertical direction) of the shielding film 801 is provided between the shielding film 801 and the inside rear surface of the housing 800. A cross-flow rotary fan 400a is connected to a motor 420 coupled to a portion of an inner surface of the suction portion 810 and is horizontally installed in the suction portion. A third barrier 833 that is vertically installed is provided in the storage portion 830 to divide the storage portion 830 into a waste section 810 and a purification section 832. An inflow hole 834 is formed to pass through the third barrier 833. A transfer pipe 320 is connected to a pump 310 installed in the purification section 832 and extends upward through the discharge portion 820 and the suction portion 830. A horizontal nozzle bar 600 is connected to an end of the transfer pipe 320, installed at an upper end portion of the suction portion 810, and provided with a plurality of nozzle holes 620 arranged at intervals in the longitudinal direction thereof (i.e. horizontal direction). A front plate of the housing 800 and the second barrier 821 are respectively provided as perforated members 803 and 822 having a plurality of through-holes.

The housing 800 has a sealed structure having an internal space that is divided into a plurality of portions. As to the housing, front portions of the suction portion 810 and the discharge portion 810 and both side portions of the discharge portion 820 are made of the perforated members 803 having a plurality of through-holes. The inside space of the housing 800 is provided with the first barrier 811 and the second barrier 821 that are horizontally installed such that the inside space of the housing 800 is divided into the suction portion 810, the discharge portion 820, and the storage portion 830, in which the first barrier 811 is disposed between the suction portion 810 and the discharge portion 820 and the second barrier 821 is disposed between the discharge portion and the storage portion 830.

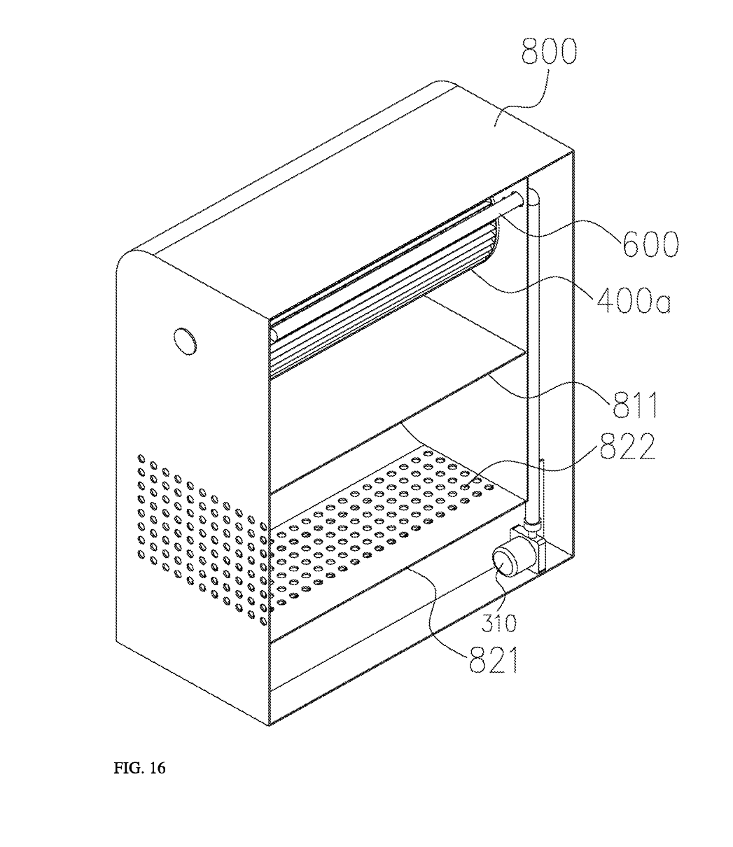

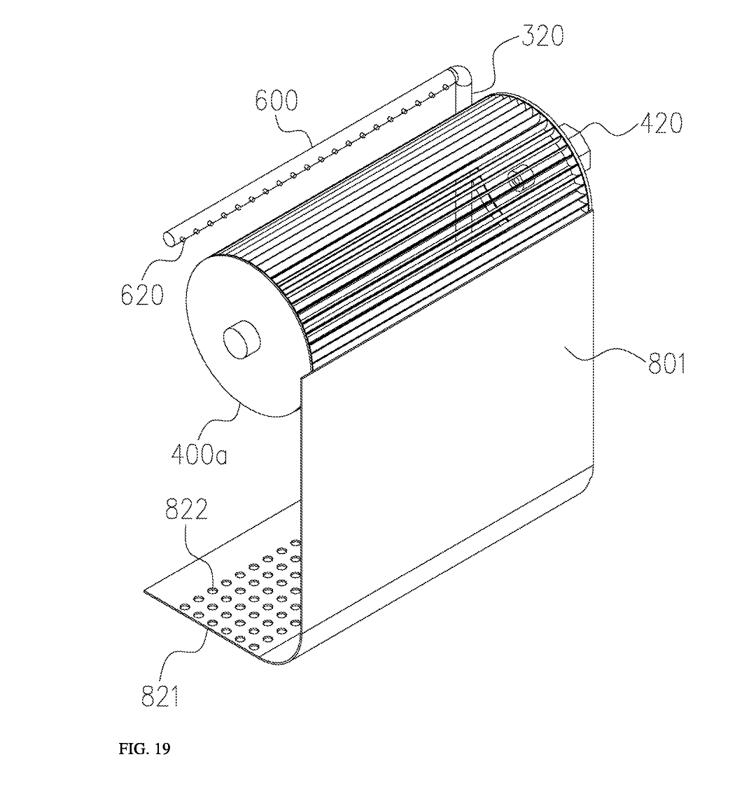

In addition, as illustrated in FIGS. 16 and 19, a perforated member 822 having a plurality of through-holes is provided at a front end of the second barrier 821 such that air in the storage portion 830 can flow to the discharge portion 822 through the perforated member and then to the outside of the air purifier 10 through the perforated member 802 provided at the front portion of the housing 800. The air discharged out of the air purifier 10 is clean air from which fine dust is removed.

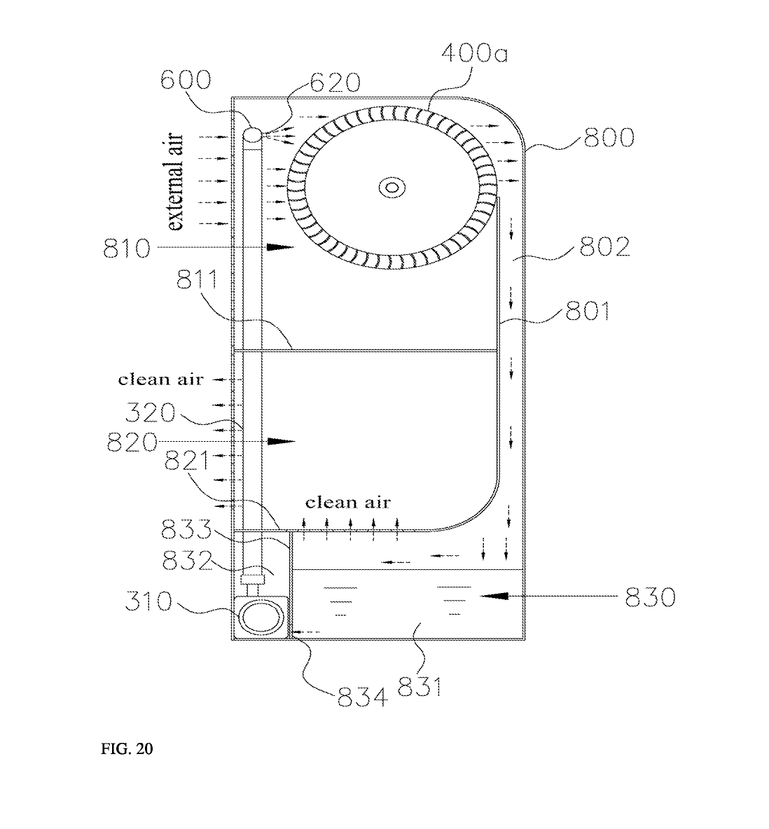

In addition, as illustrated in FIGS. 19 and 20, the shielding film 801 is coupled to the rear ends of the first barrier 811 and the second barrier 821 in a surface contact manner and arranged to extend in the vertical direction, thereby providing the narrow elongated space 802 in a rear portion of the inside space of the housing 800.

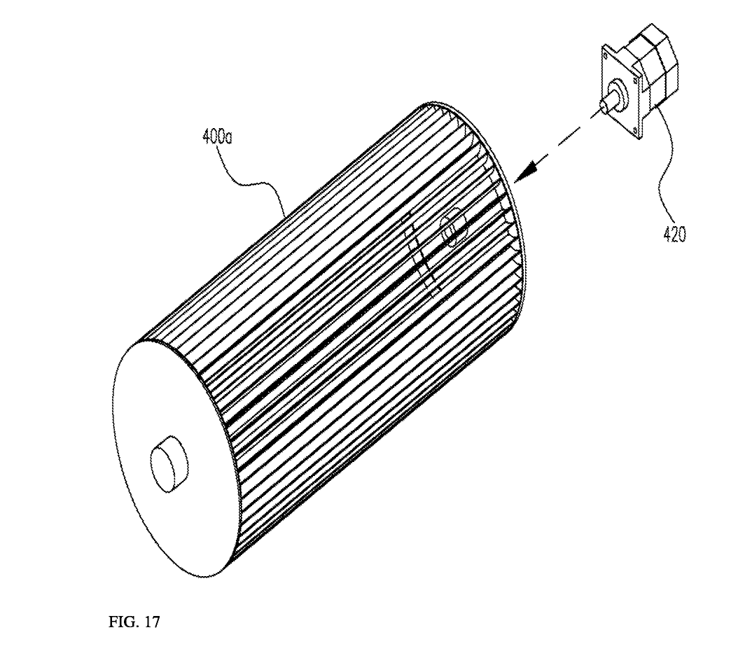

In addition, as illustrated in FIG. 17, the cross-flow rotary fan 400a that is horizontally installed is connected to the motor 420 coupled to a portion of the inner surface of the suction portion 810. The rotary fan 400a includes a plurality of blades 410a arranged in a horizontal direction. When the rotary fan 400 is rotated, external air is introduced into the suction space 810 through the perforated member 803 provided at the front portion of the housing 800, then moves through the space 820 provided in the rear portion of the inside space of the housing 810, and flows into the waste section 831 of the storage portion 803. The air introduced into the waste section 831 is discharged out of the air purifier through the perforated member 822 of the second barrier 821 provided at the upper end portion of the storage portion 830 and through the lower perforated member 803 provided at the front portion of the housing 800.

In addition, as illustrated in FIG. 20, the inside space of the storage portion 830 is divided into the waste section 831 and the purification section 832 by the third barrier 833 that is a vertically extending member. The third barrier 833 is provided with the inflow hole 834 formed to pass through the third barrier. Water in the waste section 831 of the storage portion 830 can flow into the purification section 832 through the inflow hole 834. The inflow hole 834 is provided with a filter (not shown). Therefore, fine dust contained in the water stored in the waste section 831 can be filtered out by the filter. Therefore, the water introduced into the purification section 832 is purified water.

The water introduced into the purification section 832 is transported through the transfer pipe 310 by operation of the pump 310 installed in the purification section 832 and is then sprayed into the suction portion 810 of the housing 800 through the nozzle holes 620 of the nozzle bar 600 connected to an end of the transfer pipe 320. Next, the external air and the water move through the space 820 provided at the rear portion of the inside space of the housing 800, along the movement direction of the air, due to the rotation of the rotary fan 400a while the external air and the water come into contact with each other, and then the external air and the water are guided to the waste section 831 of the storage portion 830.

The nozzle portion 600 is disposed in front of the rotary fan 400a or at a front and above position, thereby spraying water to the rotary fan 400a disposed to face the nozzle holes 620 of the nozzle portion 600.

The space portion 802 has a narrow inner diameter, thereby increasing a time for which the water and the air move. That is, a contact time and a collision time of the air and the water are maximized, and accordingly fine dust in the air can be sufficiently adsorbed onto the water.

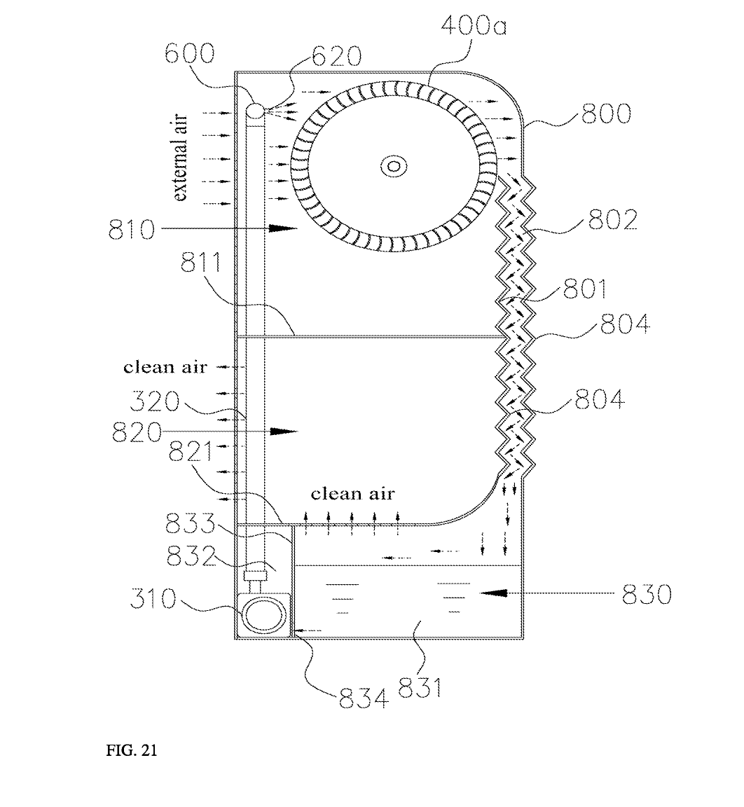

In addition, as illustrated in FIG. 21, the air purifier 10 may have the structure in which in the space portion 802, the inner surface of the shielding film 801 and the inside rear of the housing 800 are provided with concavities or convexities 804.

Since the space portion 802 is defined by the surfaces with the concavities or convexities 804, when the water and the air move through the space portion 802, the water and the air collide with each other while the water and the air move through the space portion 802 surrounded by the surfaces with the concavities or convexities 804. This increases a contact area where the water and the air can come into contact with each other, thereby increasing an adsorption efficiency of fine dust onto water.

In addition, the entire inner surface of the housing 800 is coated with silver nanoparticles. Therefore, various bacteria and viruses harmful to human bodies are removed by the silver nanoparticles. Thus, the inside of the housing is maintained in a hygienic state.

In addition, a UV sterilizing lamp (not shown) may be installed on an inside upper surface of the suction portion 810 of the housing 800 or an inside upper surface of the discharge portion 820 of the housing 800, thereby removing various bacteria or viruses contained in the air introduced into or the water sprayed into the suction portion 810 and eliminating various bacteria or viruses contained in clean air being discharged out of the discharge portion 820, so that the inside of the air purifier is maintained in a hygienic state and clean air is discharged out of the air purifier.

In addition, the air purifier can be used as a dehumidifier in such a manner that water in the storage portion 830 is completely discharged out of the air purifier through pumping, external air is forcibly introduced into the air purifier by the rotary fan, and moisture contained in the suctioned external air is removed by the UV sterilizing lamp.

As described above in connection with the embodiments, the wet air purifier can be diversely modified. The air purifier of the present invention is constructed based on the principles presented by the embodiments. It should be noted that the mechanisms based on the principles can be easily manufactured through modification of designs by those skilled in the art.

1. A wet air purifier comprising:
an outer cover (100) having a top surface made of a perforated member (110) and a closed outer side surface;
an air discharge portion (200) provided under the outer cover (100) and having a plurality of discharge holes (210) each of which is open at a bottom and at an outer side surface thereof and a plurality of through-holes (220) each of which is open at a top surface thereof and is disposed at an inner position than the discharge hole (210);
a storage tank (300) installed under the air discharge portion (200) and provided with a purification container (300b) installed therein;
a cross-flow rotary fan (400a) installed in the outer cover (100) and connected to a motor (420) coupled to a top center portion of the air discharge portion (200);
an inner cover (500) installed between the outer cover (100) and the rotary fan (400a) and having an open top and a closed outer side surface; and
a nozzle portion (600) installed at an upper end of the inner cover (500) and connected to an end of a transfer pipe (320) that is connected to a pump (310) installed in the purification container (300b) of the storage tank (300a) at a lower end thereof and which extends upward to pass through the air discharge portion (200) and through a space portion between the outer cover (100) and the inner cover (500), the nozzle portion (600) having a flow channel (610) formed therein and a plurality of nozzle holes (620) formed at a bottom surface thereof.

2. The wet air purifier according to claim 1, further comprising a support portion (330) fixed to an inside bottom surface of the storage tank (300a), thereby fixing the purification container to the inside bottom surface of the storage tank (300a) when the purification container is installed on the inside bottom surface of the storage tank,
wherein the support portion (330) includes
a plurality of fixing pieces 331 respectively provided with podium portions on inner surfaces thereof, arranged at intervals in a circular circumferential direction, and fixed to the inside bottom surface of the storage tank (300a) at lower ends thereof, in which a bottom surface of the purification container (300b) is in surface contact with the podium portions 332 of the fixing pieces 331;
a plurality of first connection taps (333) each of which connects the fixing pieces (331) adjacent to each other, has a height lower than that of the podium portions (332) of the fixing pieces (331), and is fixed to the inside bottom surface of the storage tank (300a) at a lower end thereof;
a ring-shaped protrusion tap (334) arranged at an inner position than the fixing pieces (331) and fixed to the inside bottom surface of the storage tank (300a); and
a plurality of second connection taps (335) that connects the protrusion tap (334) with the corresponding fixing pieces (331).

3. The wet air purifier according to claim 1, further comprising an axial-flow rotary fan (400b) installed between the motor (420) and the cross-flow rotary fan (4001), the axial-flow rotary fan (400b) including: a rotary shaft (421) that connects the motor (420) with the cross-flow rotary fan (400a), and a plurality of blades (410b) arranged in a radial pattern.

4. The wet air purifier according to claim 1, wherein instead of the cross-flow rotary fan (400a), the motor (420), and the inner cover (500),
an axial-flow rotary fan (400b) is installed in the outer cover (100) and connected to a motor (420) coupled to a bottom center portion of a perforated member (110) of the outer cover (100),
a transfer pipe (320) connected to the pump (310) is bifurcated to extend toward opposite ends of the outer cover (100) and then to extend upward,
ends of the upward extended portions of the transfer pipe (320) are provided with respective nozzles holes (620), and
a filter portion (700) is installed between the bifurcated portions of the transfer pipe (320) in the outer cover (100).

5. The wet air purifier according to claim 1, wherein instead of the cross-flow rotary fan (400a) and the motor (420),
an axial-flow rotary fan (400b) is installed in the outer cover (100) and connected to a motor (420) coupled to a bottom center portion of a perforated member (110) of the outer cover (100),
an upper end of the purification container (300b) of the storage tank (300a) extends up to an inside space of the outer cover (100) and is provided with a convexly protruding hemispherical cap,
a transfer pipe (320) has a lower end connected to the pump (310) installed in the purification container (300b), extends to pass through a top center portion of the hemispherical cap of the purification container 300b, has an upper end that is disposed outside the top center portion of the hemispherical cap and which is provided with pipe-shaped nozzle portions (600) extending in opposite directions,
an inner cover (500) is installed in the outer cover (100) at a position between an inner surface of the outer cover (100) and an outer surface of the purification container (300b) and has a lower end portion that is disposed in the storage tank (300a) and which has a predetermined length.

6. The wet air purifier according to claim 5, wherein an upper end of the inner cover (500) is provided with a slipping portion (510) that is bent outward from the upper end of the inner cover (500), which horizontally extends by a predetermined length, and which is in surface contact with an inner surface of the outer cover (100).

7. The wet air purifier according to claim 1, wherein the inner cover (500) has an inner diameter that gradually increases toward to a lower end thereof.

8. The wet air purifier according to claim 5, wherein
an inner surface of the inner cover (500) and an outer surface of the purification container (300b) are provided with a plurality of protrusion bars (301, 501) that is distanced from each other and arranged in a zigzag pattern.

9. The wet air purifier according to claim 1, wherein the entire inner surface of the outer cover (100) of the air purifier, a top surface and a bottom surface of the air discharge portion (200), which are provided with the discharge holes (210) and the through-holes (220), an inner surface of the storage tank (300a), and an inner surface of the purification container (300b) are coated with silver nanoparticles.

10. The wet air purifier according to claim 1, further comprising a UV sterilizing lamp installed in the outer cover (100) or on a bottom surface of the air discharge portion (200).

11. A wet air purifier comprising:
a housing having an inside space divided into a suction portion (810) that is an upper portion thereof, a discharge portion (820) that is a middle portion thereof, and a storage portion (830) that is a lower portion thereof;
a first barrier (811) horizontally installed between the suction portion (810) and the discharge portion (820);
a second barrier (8210) horizontally installed between the discharge portion (820) and the storage portion (830);
a shielding film (801) coupled to a rear end of the first barrier (811) in a surface contact manner and extending upward by a predetermined length, and coupled to a rear end of the second barrier (821) in a surface contact manner and extending downward;
a vertically extending narrow space portion (802) provided between the shielding film (801) and an inside rear surface of the housing (800);
a cross-flow rotary fan (400) horizontally installed in the suction portion and connected to a motor (420) coupled to a portion of the suction portion (810);
a third barrier vertically installed to divide an inside space of the storage portion (830) into a waste section (831) and a purification section (832);
an inflow hole (834) formed to pass through the third barrier (833);
a transfer pipe (320) connected to a pump (310) installed in the purification section (832) and extending upward to pass through the discharge portion (820) and the suction portion (830);
a nozzle bar (600) horizontally installed, connected to an upper end of the transfer pipe (520), disposed at an upper end portion of the suction portion (810), and provided with a plurality of nozzle holes (620) arranged at intervals in a horizontal longitudinal direction thereof; and
perforated members (803, 822) having a plurality of through-holes and respectively installed at a front portion of the housing (800) and in the second barrier (821).

12. The wet air purifier according to claim 11, wherein in the space portion (802), the surface of the shielding film (810) and the inside rear surface of the housing (800) are provided with concavities or convexities (804).
